(19) United States
(12) Patent Application Publication
(10) Pub. No.: US 2018/0162432 A1
(43) Pub. Date: Jun. 14, 2018

(54) SELF-CHARGING SHOPPING CART SYSTEM WITH POWER ASSIST

(71) Applicant: Wal-Mart Stores, Inc., Bentonville, AR (US)

(72) Inventors: Matthew A. Jones, Bentonville, AR (US); Nicholaus A. Jones, Fayetteville, AR (US)

(21) Appl. No.: 15/832,661

(22) Filed: Dec. 5, 2017

Related U.S. Application Data
(60) Provisional application No. 62/431,730, filed on Dec. 8, 2016.
(60) Provisional application No. 62/431,734, filed on Dec. 8, 2016.

(51) Int. Cl. B62B 5/00; B62B 3/14

(52) U.S. Cl. CPC B62B 5/0073; B62B 3/14; B62B 5/0036; B62B 5/0053

(57) ABSTRACT

Systems, apparatuses, and methods are provided herein for shopping cart power assist. A system comprises a pressure sensor device on a handle portion of a shopping cart, a power generator configured to generate power with a rotation of a wheel system of the shopping cart, a power storage device configured to be charged by the power generator, a motor configured to drive the wheel system, and a control circuit. The control circuit being configured to detect for pressure on the handle portion of the shopping cart based on the pressure sensor device, in an event that a forward pressure on the handle portion is below a threshold, cause the power generator to charge the power storage device, and in an event that the forward pressure on the handle portion exceeds the threshold, cause the motor to drive the wheel system to generate forward propulsion for the shopping cart.

### CROSS-REFERENCE TO RELATED APPLICATIONS

This application claims the benefit of the following U.S. Provisional Application No. 62/431,730 filed Dec. 8, 2016, and U.S. Provisional Application No. 62/431,734 filed Dec. 8, 2016, which are all incorporated herein by reference in their entirety.

### TECHNICAL FIELD

This invention relates generally to shopping carts.

### BACKGROUND

Most grocery stores offer shopping carts that customers can use while they are shopping in the store. These shopping carts generally have a basket portion, a handle, and wheels.

### BRIEF DESCRIPTION OF THE DRAWINGS

Disclosed herein are embodiments of apparatuses and methods for a shopping cart system. This description includes drawings, wherein:

FIG. 1 is an illustration of a shopping cart in accordance with several embodiments;

FIG. 2 is a block diagram of a system in accordance with several embodiments;

FIG. 3 is a flow diagram in accordance with several embodiments;

FIGS. 4A, 4B, and 4C. are illustrations of movement controls in accordance with several embodiments;

FIG. 5 is a flow diagram in accordance with several embodiments;

FIG. 6 is an illustration of energy information of a shopping cart system in accordance with several embodiments; and

FIG. 7 is a flow diagram in accordance with several embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein for a shopping cart system. In some embodiments, a system for providing shopping cart power assist comprises a pressure sensor device on a handle portion of a shopping cart, a power generator configured to generate power with a rotation of a wheel system of the shopping cart, a power storage device configured to be charged by the power generator, a motor configured to drive the wheel system of the shopping cart with power from the power storage device, and a control circuit coupled to the pressure sensor device and the motor. The control circuit being configured to detect for pressure on the handle portion of the shopping cart based on the pressure sensor device, in an event that a forward pressure on the handle portion is below a threshold, cause the power generator to charge the power storage device, and in an event that the forward pressure on the handle portion exceeds the threshold, cause the motor to drive the wheel system to generate forward propulsion for the shopping cart.

In some embodiments, a system for tracking shopping cart activity comprises a shopping cart system comprising a power generator configured to generate power with a rotation of a wheel system of the shopping cart, a power storage device configured to be charged by the power generator and a system connector configured to couple with a computer system to provide energy information associated with the charging of the power storage device. The computer system comprising a shopping cart connector configured to couple with the system connector to receive the energy information from the shopping cart system and a control circuit configured to estimate a distance traveled by the shopping cart system based on the energy information.

Generally speaking, pursuant to various embodiments, systems, apparatuses and methods are provided herein for a shopping cart system. In some embodiments, a system for providing shopping cart power assist comprises a pressure sensor device on a handle portion of a shopping cart, a power generator configured to generate power with a rotation of a wheel system of the shopping cart, a power storage device configured to be charged by the power generator, a motor configured to drive the wheel system of the shopping cart with power from the power storage device, and a control circuit coupled to the pressure sensor device and the motor. The control circuit being configured to detect for pressure on the handle portion of the shopping cart based on the pressure sensor device, in an event that a forward pressure on the handle portion is below a threshold, cause the power generator to charge the power storage device, and in an event that the forward pressure on the handle portion exceeds the threshold, cause the motor to drive the wheel system to generate forward propulsion for the shopping cart.

In some embodiments, a system for tracking shopping cart activity comprises a shopping cart system comprising a power generator configured to generate power with a rotation of a wheel system of the shopping cart, a power storage device configured to be charged by the power generator and a system connector configured to couple with a computer system to provide energy information associated with the charging of the power storage device. The computer system comprising a shopping cart connector configured to couple with the system connector to receive the energy information from the shopping cart system and a control circuit configured to estimate a distance traveled by the shopping cart system based on the energy information.

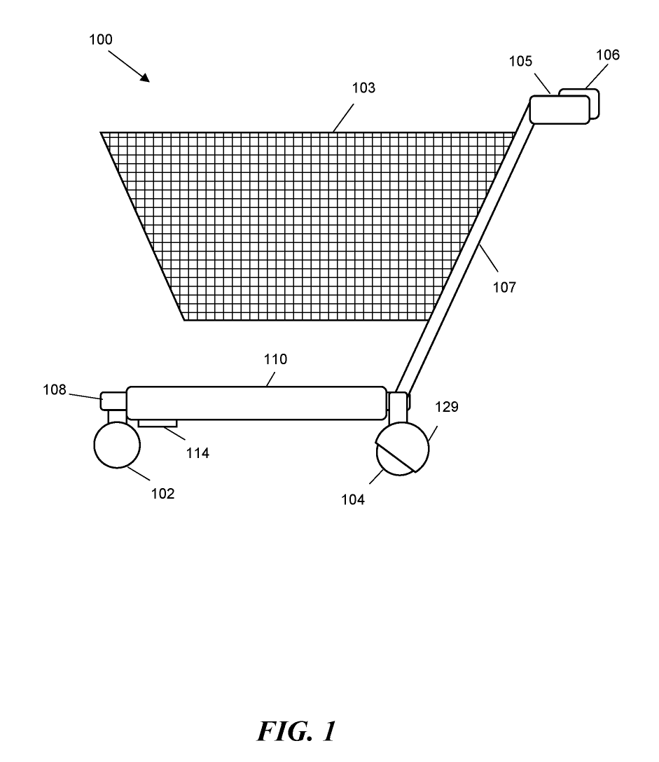

Referring now to FIG. 1, a shopping cart apparatus is shown. The shopping cart 100 includes a basket portion 103, a handle portion 105, a pressure sensor device 106, a vertical frame portion 107, a bottom frame 108, one or more front wheels 102, and one or more back wheels 104. The shopping cart 100 further includes a power assembly comprising a generator 129, a power storage device 110, and a connector 114.

The shopping cart 100 may generally comprise a moveable item container configured to travel in a shopping space. The basket portion 103 may be configured to hold a plurality of items for a customer while the customer shops in a store. In some embodiments, the basket portion 103 may include other conventional components of a shopping cart not shown in FIG. 1 such as a child seat, a swinging rear door, a divider, etc.

The handle portion 105 is generally configured to be held by a user when the shopping cart 100 is pushed or pulled. The pressure sensor device 106 may comprise a mechanical and/or electrical pressure sensor configured to detect the pressure associated with a customer pushing and/or pulling on the handle portion 105. In FIG. 1, the pressure sensor device 106 is positioned to come in contact with a customer's hand when the customer pushes or pulls the shopping cart via the handle portion 105. In some embodiments, the pressure sensor device 106 may be positioned between the handle portion 105 and the frame of the shopping cart 100 to detect for the pressure on the handle portion 105. In some embodiments, the pressure sensor device 106 may be integrated into the handle portion 105. In some embodiments, the pressure sensor device 106 comprises a right pressure sensor and a left pressure sensor spaced apart from each other on the handle portion of the shopping cart and configured to separately detect for pressure on each side of the handle portion 105 of the shopping cart 100.

The vertical frame portion 107 couples the handle portion 105 and the basket portion 103 to the bottom frame 108. In some embodiments, two or more of the vertical frame portion 107, the basket portion 103, the handle portion 105, and the bottom frame 108 may be formed of a continuous material. In some embodiments, the shopping cart 100 may be configured to be docked or stacked with other similar shopping carts. For example, the basket portion 103 may comprise a swinging rear door that is configured to be pushed open by the basket portion of another shopping cart to dock the shopping carts together to reduce the space needed for cart storage.

The bottom frame 108 is generally be configured to couple the front wheels 102 to the back wheels 104. In some embodiments, the bottom frame 108 may comprise a U-shaped structure that is open in the back of the shopping cart 100 for receiving another similar shopping cart between the back wheels 104. In some embodiments, the bottom frame 108 may be narrower and/or lower in the front and wider and/or higher in the back to allow a series of similar shopping carts to dock with one another front to back. In some embodiments, the front wheels 102 and/or the back wheels 104 may comprise a conventional wheel system configured to travel in a shopping space. In some embodiments, the shopping cart may comprise a single front wheel and the bottom frame may comprise a V-shaped structure. In some embodiments, the shopping cart 100 may comprise two front wheels. In some embodiments, the front wheels 102 may comprise pivoting axles that allow the axle orientation of the front wheel(s) to turn left and right relative to the body of the shopping cart. In some embodiments, the back wheels 104 may comprise fixed axles such the axle orientations of the back wheels 104 are fixed relative to the body of the shopping cart 100.

The generator 129 may be coupled to one or more wheels of the shopping cart 100 and may generally comprise any device configured to convert kinetic energy from the rotation of the wheel to electrical energy. In some embodiments, the generator 129 may comprise a stator element and a rotator element for generating energy from the rotation of the wheel. Generally, the rotation of the wheel may cause the relative motion between the stator element and the rotator element of the generator 129. In some embodiments, the generator may comprise lap and/or wave winding. While the generator 129 is shown to be coupled to the back wheel 104 in FIG. 1, in some embodiments, the generator 129 or a second generator may be coupled to the front wheel 102

In some embodiments, the shopping cart 100 may further comprise a motor for driving one or more of the front wheel 102 and the back wheel 104 to provide power assist to persons pushing the shopping cart 100. In some embodiments, the generator 129 may comprise a motor/generator device configured to operate in a motor mode and a generator mode. For example, the same set of stator element and/or rotator element may be configured to generate energy from the rotation of the wheel and drive the rotation of the wheel with electrical energy. In some embodiments, a stator element may be shared by a first set of rotator elements associated with the motor 220 and a second set of rotator elements associated with the power generator 240. In some embodiments, the switch 235 may be configured to selectively engage one of the two sets of rotator elements to switch the operating mode of the combination device between a motor mode and a generator mode. In some embodiments, the motor may comprise a separate device from the generator 129. In some embodiments, the motor and the generator 129 may be coupled to same or different wheels on the shopping cart 100. For example, the generators 129 may be coupled to the back wheels 104 while the motor may be configured to drive the front wheels 102. In some embodiments, one or more wheels of the shopping cart may comprise a generator 129 and/or a motor for driving the wheel. In some embodiments, a shopping cart may comprise any number of generators 129 and/or motors. In some embodiments, one or more of the motor and the generator 120 may be configured for regenerative braking that converts the kinetic energy of braking the shopping cart 100 into electrical energy for the power storage device 110.

The power storage device 110 may comprise one or more of a battery and a capacitor. In some embodiments, the power storage device 110 may comprise a capacitor element that is cylindrically shaped and a portion of the bottom frame 108 may comprise the core of the cylindrical capacitor element. In some embodiments, a portion of the bottom frame 108 may comprise an electrode of the power storage device 110. For example, an elongated member of the bottom frame 108 may be coupled to a negative terminal of the generator 120 to serve as the electrode of the capacitor. The elongated member of the bottom frame 108 may be wrapped with a dielectric material and another electrode that is coupled to a positive terminal. In some embodiments, dielectric material and an electrode core may be inserted into an elongated member of the bottom frame to form a capacitor within the hollow of the bottom frame. While the power storage device 110 is shown to be coupled to the bottom frame 108 of the shopping cart 100, in some embodiments, the power storage device 110 may be coupled to other portions of the shopping cart 100 such as the vertical frame portion 107, the handle portion 105, and the basket portion 103.

In some embodiments, the generator 129, the motor, and the power storage device 110 are electrically coupled in a way as to allow the generator 129 to charge the power storage device 110 with the rotation of the wheels and allow the motors to drive the wheels with the power stored in the power storage device 110. In some embodiments, the control circuit on the shopping cart 100 may be configured to switch the system between a charging mode and a power assist mode based on pressures detected at the pressure sensor device 106. In some embodiments, the control circuit may further be configured to switch the system to a neutral mode in which either the generator 129 nor the motor are engaged.

The connector 114 may generally comprise a wired or wireless connection configured to couple to one or more of other similar shopping carts, a discharge device, a point of sale (POS) system, a data connector, and the like. In some embodiments, the connector 114 may comprise an electrical contact configured to transfer the power stored in the power storage device 110 to another device. For example, the power stored in the power storage device 110 may be discharged to a power grid to be used by other devices or be used to power a cart pusher device, etc. In some embodiments, the connector 114 may comprise a data connector configured to provide energy information of the power storage device 110 to a central computer system. In some embodiments, the data connector may comprise a wired data port and/or a wireless transceiver such as one or more of a Wi-Fi transceiver, a Bluetooth transceiver, a near field communication (NFC) transceiver, a radio frequency transceiver, etc. While the connector 114 is shown to be positioned at the bottom of the power storage device 110 in FIG. 1, the connector may generally be positioned at any portion of the shopping cart 100. In some embodiments, the connector 114 may be positioned to contact a shopping cart connector 265 at a POS system when the shopping cart 100 travels through the POS system.

While a standard one basket type shopping cart is shown in FIG. 1, in some embodiments, the generator assembly may also be similarly coupled to other types of shopping carts such as two basket type shopping carts, flatbed shopping carts, foldable shopping carts, etc.

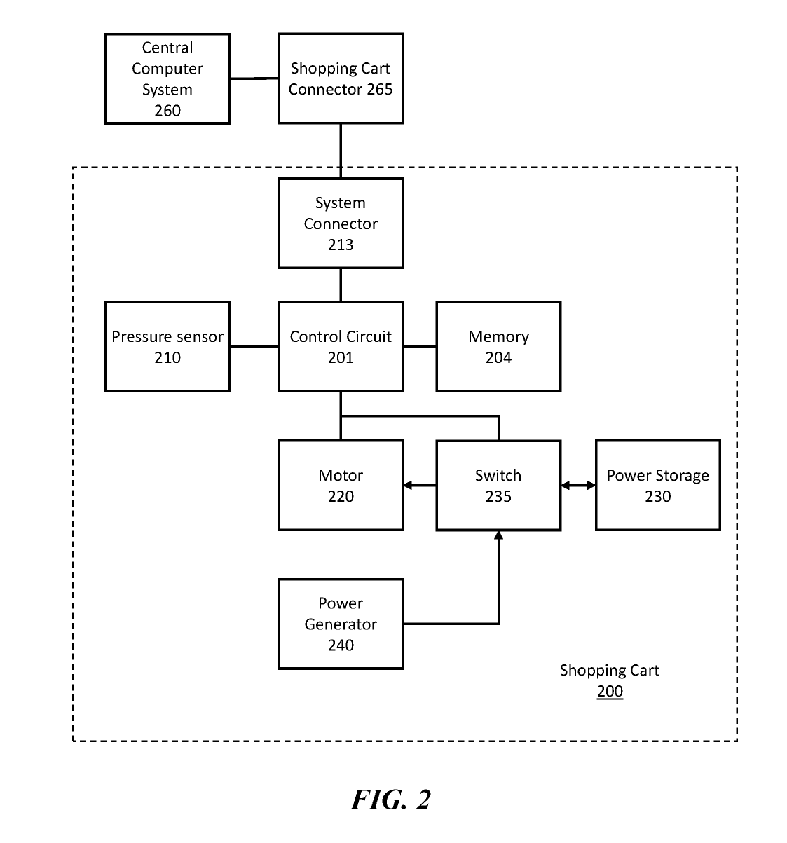

Referring now to FIG. 2, a block diagram of a system according to some embodiments is shown. The system comprises a shopping cart system 200 and a central computer system 260 coupled through a shopping cart connector 265.

The shopping cart system 200 comprises a control circuit 201, a pressure sensor 210, a memory 204, a motor 220, a switch 235, a power generator 240, a power storage 230, and a system connector 213. In some embodiments, the shopping cart system 200 may further comprise the physical structures of a shopping cart configured to carry items for customers in a retail store. In some embodiments, the shopping cart system 200 may comprise the shopping cart 100 described with reference to FIG. 1 herein or a similar device.

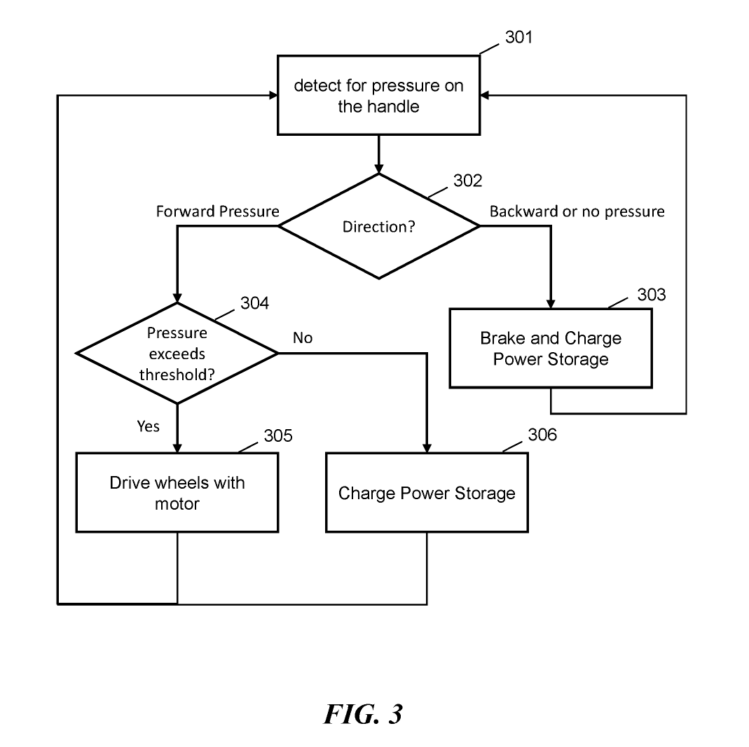

The control circuit 201 may comprise one or more of a processor, a microprocessor, a microcontroller, and the like. In some embodiments, the control circuit 201 may comprise hardwired control circuitry, a processor executing software instruction, or a combination of the two. In some embodiments, the control circuit 201 is configured to execute computer readable codes stored in the memory 204. In some embodiments, the control circuit 201 is configured to operate the switch 235 to switch between a charging mode and a power assist mode based on inputs received at the pressure sensor 210. In some embodiments, the control circuit 201 may be configured to drive the motor 220 based on inputs received at the pressure sensor 210. In some embodiments, the control circuit 201 may further be configured to record energy information of the shopping cart system 200 into the memory 204. For example, as a shopping cart travels with a customer, the control circuit 201 may record the amount of charge being added to and/or removed from the power storage 230 over time. In some embodiments, the control circuit may be configured to measure the charge level of the power storage 230 periodically and/or when prompted by the central computer system 260. In some embodiments, the control circuit 201 may be configured to perform one or more steps described with reference to FIGS. 3, 5, and 7 described herein. The memory 204 may comprise non-volatile and/or volatile computer-readable memories. In some embodiments, the memory 204 stores a set of instructions to be executed by the control circuit 201 to perform one or more steps described with reference to FIGS. 3, 5, and 7 described herein. In some embodiments, the memory 204 may comprise a memory storage device configured to aggregate the energy information over time as the shopping cart system 200 travels. In some embodiments, the energy information stored in the memory 204 may be configured to be provided to the central computer system 260 when the system connector 213 is coupled to the shopping cart connector 265. In some embodiments, the memory 204 may be configured to reset the energy information record or start a new energy information record each time the shopping cart arrives at a point of sale system, a shopping cart carousel, and/or a shopping cart retrieval area.

The pressure sensor 210 may comprise a mechanical and/or electrical pressure sensor configured to detect the pressure associated with a customer pushing and/or pulling on the shopping cart system 200. In some embodiments, the pressure sensor 210 may be positioned to come in contact with a customer's hand when the customer pushes or pulls the shopping cart via a handle portion. In some embodiments, the pressure sensor 210 may be positioned between the handle portion and the frame of the shopping cart system 200 to detect for the pressure on the handle portion relative to the body of the shopping cart. In some embodiments, the pressure sensor device 106 may be integrated into the handle portion of the shopping cart system 200. In some embodiments, the pressure sensor device 106 comprises a right pressure sensor and a left pressure sensor spaced apart from each other on the handle portion of the shopping cart 100. The control circuit 201 may be configured to separately measure the pressures on the right and left pressure sensors to determine how to provide power assist and/or steer the shopping cart via the motor 220. In some embodiments, the pressure sensor 210 may comprise the pressure sensor device 106 described with reference to FIG. 1 or a similar device.

The power storage 230 may generally comprise a device configured to store power generated by the power generator 240 and supply power to the motor 220. In some embodiments, the power storage 230 may comprise one or more of a battery and a capacitor. In some embodiments, the power storage 230 may comprise a capacitor element that is cylindrically shaped and a portion of the bottom frame of the shopping cart system 200 may comprise the core of the cylindrical capacitor element. In some embodiments, the power storage 230 may be coupled to a sensor for measuring the state of charge of the power storage 230. In some embodiments, the state of charge sensor may comprise a voltmeter, an Amp-hour meter, and the like. In some embodiments, the state of energy information of the power storage 230 may be collected by the control circuit 201 and stored in the memory 204.

The switch 235 may comprise a mechanical and/or electrical switch controlled by the control circuit 201 to switch between at least a charging mode and a power assist mode. In some embodiments, the switch may further cause the motor 220 and/or the power generator 240 to enter a regenerative braking mode. In some embodiments, the switch 235 may further be switched to a neutral mode in which neither the motor 220 nor the power generator 240 is engaged and/or a reverse mode in which the motor 220 is driven in reverse. In some embodiments, the switch 235 may be controlled by the control circuit 201 based on the pressure detected by the pressure sensor 210. In some embodiments, when a forward pressure detected at the pressure sensor 210 exceeds a threshold, the switch 235 may supply power from the power storage 230 to the motor 220 to allow the motor 220 to drive one or more wheels on the shopping cart system 200. In some embodiments, when a forward pressure is below a threshold, the switch 235 may couple the power generator 240 to the power storage 230 to charge the power storage with the rotation of the wheels. In some embodiments, the switch 235 may further charge the power storage 230 with the power generator 240 and/or the motor 220 through regenerative braking. In some embodiments, the switch 235 and/or a separate device may be configured to monitor the charge going in and out of the power storage 230. In some embodiments, the monitored charge flow may be stored in the memory 204 as energy information. In some embodiments, the switch 235 may be at least partially integrated with the control circuit 201. In some embodiments, the motor 220 and the power generator 240 may comprise a combination motor and generator and the switch 235 may comprise a mode switch of the combination device.

The motor 220 may comprise one or more AC and/or DC motors configured to drive one or more wheels of the shopping cart system 200. In some embodiments, the shopping cart system 200 may comprise a plurality of motors for driving different wheels. In some embodiments, the motor 220 may comprise a variable speed motor configured to supply different amounts of torque to one or more wheels. In some embodiments, the amount of torque applied by the motor 220 may be determined based on the amount of pressure detected by the pressure sensor 210. In some embodiments, one or more motors 220 may be configured to apply different torque to different wheels to cause the shopping cart to turn. For example, if more pressure is detected on the left side of the shopping cart handle, the control circuit 201 may cause the motor 220 to supply more torque to a left wheel to cause the shopping cart to take a right turn. In some embodiments, the motor 220 may further be configured to operate in reverse. For example, if a backward pressure is detected on the handle when the shopping cart is stopped, the motor 220 may be configured to drive the wheels in the direction of the pull. In some embodiments, the wheel system of the shopping cart may comprise one or more powered and unpowered wheels.

The power generator 240 comprises a device configured to convert kinetic energy from the rotation of the wheel to electrical energy. In some embodiments, the power generator 240 may be coupled to one or more wheels of the shopping cart system 200. In some embodiments, the power generator 240 may comprise a stator element and a rotator element for generating energy from the rotation of the wheel. Generally, the rotation of the wheel may cause the relative motion between the stator element and the rotator element of the power generator 240. In some embodiments, the generator may comprise lap and/or wave winding.

In some embodiments, the motor 220 and the power generator 240 may comprise a combined motor and generator device configured to operate in motor mode and generator mode. For example, the same set of stator element and/or rotator element may be configured to generate energy from the rotation of the wheel and drive the rotation of the wheel with electrical energy. In some embodiments, a stator element may be shared by a first set of rotator elements associated with the motor 220 and a second set of rotator elements associated with the power generator 240. In some embodiments, the switch 235 may be configured to selectively engage one of the two sets of rotator elements to switch the operating mode of the combination motor/generator device. While the switch 235 is shown to couple the power storage 230 to the motor 220 and the power generator 240, in some embodiments, the switch 235 may comprise a mode switch of the motor/generator combination device. In some embodiments, the motor 220 and/or the power generator 240 may comprise the generator 129 described with reference to FIG. 1 or a similar device.

The system connector 213 comprises a connector configured to allow the shopping cart system 200 to send data and/or power to the central computer system 260. In some embodiments, the system connector 213 may comprise a wired or wireless connection configured to couple to one or more a shopping cart connector 265 associated with the central computer system 260, other similar shopping carts, a discharge device, a point of sales system, and the like.

In some embodiments, the system connector 213 may comprise an electrical contact configured to transfer power from the power storage 230 to another device such as the shopping cart connector 265. For example, the power stored in the power storage 230 may be transferred to a power grid to be used by other devices, to power a cart pusher device, etc. In some embodiments, the system connector 213 may be coupled to the power storage 230 to allow the shopping cart connector 265 to measure the charge level of the power storage 230. In some embodiments, the charge level of the power storage 230 may be measured by discharging power through the system connector 213.

In some embodiments, the system connector 213 may comprise a data connector configured to provide energy information stored in the memory 204 to the central computer system 260. In some embodiments, the system connector 213 may comprise a wired data connector and/or a wireless transceiver such as one or more of a Wi-Fi transceiver, a Bluetooth transceiver, a near field communication (NFC) transceiver, a radio frequency transceiver, etc. In some embodiments, the system connector 213 may be configured to automatically couple to the shopping cart connector 265 when the shopping cart system 200 is near a POS system, in a cart return area, or in a cart carousel etc. In some embodiments, the system connector 213 may be configured to couple to system connectors of other shopping carts when the shopping carts are docked together. Data and/or charge may be transferred to the shopping cart connector 265 and/or the central computer system via a chain of system connectors on a plurality of shopping carts. While the system connector 213 is shown to be coupled to the control circuit 201 in FIG. 1, in some embodiments, the system connector 213 may be alternatively or additionally coupled to the power storage 230 and/or the memory 204. In some embodiments, the system connector 213 may comprise the connector 114 described with reference to FIG. 1 or a similar device.

The shopping cart connector 265 may comprise a connector configured to receive data and/or charge from the shopping cart system 200. In some embodiments, the shopping cart connector 265 may comprise an electrical connection configured to measure the state of charge of the power storage 230 with or without discharging the power storage 230. In some embodiments, the shopping cart connector 265 may be configured to at least partially discharge the power storage 230 and measure the amount of charge received from the power storage 230. In some embodiments, the shopping cart connector 265 may comprise a data connection configured to receive data stored in the memory 204 of the shopping cart system 200. In some embodiments, the transferred data may comprise energy information associated with the energy generated and/or used by the shopping cart system 200. In some embodiments, the shopping cart connector 265 may comprise a wired data connector and/or a wireless transceiver such as one or more of a Wi-Fi transceiver, a Bluetooth transceiver, a near field communication (NFC) transceiver, a radio frequency transceiver, etc. In some embodiments, the shopping cart connector 265 may comprise a connector at a POS system such as a checkout counter. For example, the shopping cart connector 265 may comprise an electrical contact positioned at a checkout counter that is configured to come in contact with the system connector 213 when the shopping cart system 200 travels through the checkout counter.

The central computer system 260 may comprise a processor-based device comprising a control circuit and a memory. In some embodiments, the central computer system 260 is configured to receive energy information from the shopping cart systems 200 via the shopping cart connector 265. In some embodiments, the central computer system 260 may be configured to determine the distance traveled by the shopping cart system 200 based on the energy information. For example, the central computer system may be configured to estimate the total distance traveled by the shopping cart system 200 based on the state of the charge of the power storage 230 when the shopping cart system 200 is coupled to the shopping cart connector 265. In some embodiments, the shopping cart system 200 may record energy information over time and the central computer system 260 may be configured estimated the travel distance based on the stored energy information record. In some embodiments, the central computer system 260 may be configured to detect for stop events and/or item added events based on the energy information record. In some embodiments, the central computer system 260 may further be coupled to a POS system (not shown) that records customer purchases and/or a store layout database (not shown) that stores the locations of a plurality of products offered for sale at a store location. In some embodiments, the central computer system 260 and/or a POS system may be configured to associate a purchase with energy information from a shopping cart system 200. For example, a purchase processed at a checkout counter may be associated with a shopping cart coupled to the shopping cart connector 265 of the same checkout counter. In some embodiments, the central computer system 260 may be configured to estimate a travel path of the shopping cart system based on the customer purchase record and the distance traveled. For example, the central computer system 260 may determine the display locations of the purchased items based on a store layout and estimate the customer's route based on the estimated distance of the trip and the display locations of the items in the store. In some embodiments, the central computer system 260 may be configured to aggregate a total travel distance of the shopping cart based on a plurality of estimated travel distances and generate a shopping cart service task when the total travel distance of the shopping cart exceeds a threshold. In some embodiments, the central computer system 260 may comprise a control circuit configured to execute computer readable instructions stored on a memory device and perform one or more steps described with reference to FIGS. 3, 5, and 7 described herein.

While one shopping cart system 200 is shown in FIG. 2, in some embodiments, the central computer system 260 may be configured to receive energy information from a plurality of shopping cart systems 200 in a shopping space. In some embodiments, the shopping cart system 200 may comprise other components such as a mobile device charging dock, a user interface device, a short range transceiver configured to communicate with a customer mobile device, etc.

In some embodiments, the shopping cart system 200 may comprise a power assist switch for a customer and/or an associate to enable and disable the power assist function of the shopping cart system 200. In some embodiments, when power assist is disabled, the control circuit 201 and/or the switch 235 may not turn on the motor 220 to drive the wheel system of the shopping cart system 200. The shopping cart system 200 may operate in a charge-only mode in which the rotation of the wheel always charges the power storage 230. In some embodiments, the shopping cart system 200 may comprise a charge switch for a customer and/or an associate to enable and disable the charging function of the shopping cart system 200. For example, if a particular frail customer wishes to push a shopping cart system 200, the charge switch may be turned off to reduce the resistance on the wheels to make the cart easier to push. In some embodiments, power assist may be enabled and charging may be disabled such that the shopping cart system 200 uses previously stored energy to operate the shopping cart in power-assist only mode. In some embodiments, one or more shopping cart systems may not comprise a motor 220 and only be configured to charge the power storage 230 with the rotation of the wheel without providing power assist.

In some embodiments, whether the power assist mode and/or charge mode is enabled or disabled, the control circuit 201 may still trigger regenerative braking based on the pressure detected by the pressure sensor 210. For example, regenerative braking may be engaged if no pressure or a backward pressure is detected by the pressure sensor 210. In some embodiments, the regenerative braking may be selectively disabled on the shopping cart system 200.

Referring now to FIG. 3, a method for providing power assist to shopping carts is shown. In some embodiments, the steps of FIG. 3 may be performed by a control circuit of a shopping cart system. In some embodiments, the steps of FIG. 3 may be performed by the central computer system 260 and/or the shopping cart system 200 described with reference to FIG. 2 or similar devices.

In step 301, the system detects for pressure on the handle of the shopping cart. In some embodiments, the pressure on the handle is detected by a pressure sensor device. In some embodiments, the pressure sensor device may comprise the pressure sensor device 106 described with reference to FIG. 1, the pressure sensor 210 described with reference to FIG. 2, and/or a similar device. In some embodiments, the system may separately detect for pressure on different sides of the handle in step 301.

In step 302, the system determines the direction of the pressure. In some embodiments, pressures in different directions may be detected by same or different sensor units of the pressure sensor device. In some embodiments, the direction of the pressure may be determined relative to the orientation of the shopping cart. For example, the handle portion of the shopping cart may be considered the back of the shopping cart and a pressure pulling the handle portion away from the basket portion may be considered a backward pressure. In some embodiments, the direction of the pressure may be determined relative to the direction to the shopping's current direction of travel. For example, if the shopping cart is currently traveling with the handle portion forward (e.g. a customer is pulling the cart instead of pushing), a forward pressure may comprise a pressure pulling the handle portion away from the basket portion and in the direction of travel. On the other hand, if the shopping cart is currently traveling with the basket portion forward (e.g. the customer is pushing the cart from behind), a forward pressure may comprise pressure pushing the handle portion toward the basket portion and in the direction of travel.

If a backward pressure or no pressure is detected in step 302, the process proceeds to step 303. A backward pressure on the handle of the shopping cart may correspond to a customer trying to slow down the cart. The absence of pressure on the shopping cart may correspond to a customer having released the shopping cart and/or that the shopping cart is traveling away from the customer. In step 303, the system causes the power generator to charge the power storage device while bringing the shopping cart to a stop. In some embodiments, step 303 may comprise regenerative braking that charges the power storage with the energy generated by the brake. In some embodiments, the system may allow for a pressure and/or time threshold before engaging the regenerative brake. For example, the brake may only be engaged if a backward pressure exceeds a set amount of force and/or a set time period. In some embodiments, braking may similarly be engaged only if no pressure is detected for a set period of time. In some embodiments, the system may further be configured to record an amount of energy associated with bringing the shopping cart a stop in a memory storage. In some embodiments, if backward pressure is detected when the shopping cart is in a stopped state or is traveling in reverse, the shopping cart may be allowed to travel backward with or without power assist. In some embodiments, the backward pressure exceeds a threshold, the system may cause the motors to drive the wheels in reverse to provide power assist while the customer pulls the cart. In some embodiments, the system may be configured to limit the speed of a backward travel.

If a forward pressure is detected in step 302, the process proceeds to step 304 and the system determines whether the pressure exceeds a threshold. In some embodiments, the threshold value may correspond to the force associated with overcoming the inertia of a stopped shopping cart. For example, the force threshold may correspond to 20N, 40N, 100N, etc. In some embodiments, the threshold may correspond to the typical push strength of an elderly customer. A forward pressure exceeding the threshold may correspond to a customer having difficulties overcoming the inertia of the shopping cart. The motor then supplies additional torque to the wheel to help the customer overcome the inertia of the shopping cart. A forward pressure below the threshold may correspond to a shopping cart traveling with momentum at approximately constant speed with the customer pushing the shopping cart.

If the forward pressure exceeds the threshold in step 304, the system engages the motor of the shopping cart system in step 305 and drives the wheels of the shopping with energy stored in a power storage of the shopping cart. In some embodiments, the system may further be configured to record an amount of energy used to drive the wheels and/or the duration of the power assist in a memory storage. In some embodiments, the wheel system may comprise a powered right wheel and a powered left wheel and the system may drive the powered right wheel based on a first pressure detected at the right pressure sensor and drive the powered left wheel based on a second pressure detected at the left pressure sensor. In some embodiments, the customer may use the handle to steer the shopping cart while in power assist mode.

If the forward pressure is present but is below a threshold, in step 306, the system may assume that the cart is traveling with sufficient momentum and charges the power storage with the rotation of the wheel. In some embodiments, a combination motor and generator device on the shopping cart may be switched to a motor mode in step 305 and switched to a generator mode in step 306. In some embodiments, a switch coupling a power storage to a motor device and generator device may be configured to couple the power storage to the motor in step 305 and couple the power storage to the generator in step 306.

After steps 305, 306, and 303, the process may return to step 301 and the system may selectively engage the motor and/or the generator of the shopping cart system as the shopping cart continues to travel in the shopping space. For example, if the forward pressure on the handle portion falls below the threshold while the motor is driving the wheel system in step 305, the system may proceed to step 306, turn off the motor and begin to charge the power storage device with the power generator coupled to the wheel system.

In some embodiments, if the power assist capability is turned off on a shopping cart system, in step 305, the system may charge the power storage similar to step 306 or may temporally disengage the generator to reduce the resistance of the wheels as a customer overcomes the inertia of the shopping cart. In some embodiments, if the charging is disabled on the shopping cart system, in step 306, the system may disengage the generator to reduce the resistance of the wheels as a customer pushes the shopping cart around the shopping space.

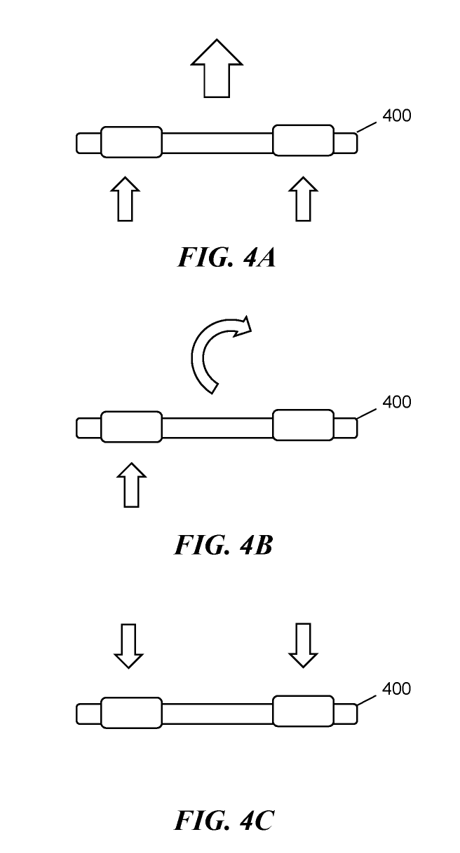

Referring now to FIGS. 4A-C, illustrations of shopping cart direction control are shown. FIGS. 4A-C generally illustrates the direction of the power assist based on the pressure applied to the handle 400 of the shopping cart. In FIG. 4A, when approximately equal forward pressure is applied to both sides of the handle 400, the power assist provides a forward drive. For example, the system may drive left and right wheels at approximately the same speed. In FIG. 4B, when a greater pressure is applied to the left side of the handle 400, power assist causes the shopping cart to turn right. In some embodiments, the sharpness of the turn may depend on the amount of pressure applied to the left side of the handle and/or the difference in the pressure between the two sides of the handle. In some embodiments, a backward pressure on the right side of the handle 400 in place of or in additional to the forward pressure on the left side of the handle 400 may also cause the power assist system to turn the shopping cart to the right. In some embodiments, the turning of the shopping cart may be caused by driving the wheels of the shopping cart at different speeds and/or torques. In FIG. 4C, when backward pressures are detected on both sides of the handle 400, the shopping cart system applies regenerative braking and brings the shopping cart to a stop. In some embodiments, when no pressure is detected on the handle 400, the system may engage a dead-man switch and similarly apply regenerative braking to bring the shopping cart to a stop. In some embodiments, if the shopping cart is already stopped, the power assist system may drive the shopping cart in reverse when backward pressure is detected.

The illustrations show in FIG. 4A-4C are provided as examples only. In some embodiments, a shopping cart may respond to pressures on the handle differently depending on the cart's direction of travel and/or the mode the cart is currently operating in. For example, when power assist is turned off, the cart may only be configured to brake as described with reference to FIG. 4C.

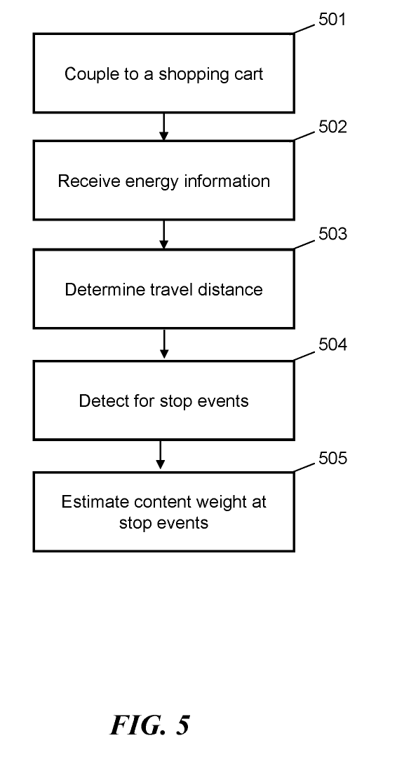

Referring now to FIG. 5, a method for tracking shopping cart activity is shown. In some embodiments, the steps of FIG. 5 may be performed by a control circuit of a shopping cart system, a central computer system, and/or a POS system. In some embodiments, the steps of FIG. 5 may be performed by the central computer system 260 and/or the shopping cart system 200 described with reference to FIG. 2 or similar devices.

In step 501, the system couples to a shopping cart system. In some embodiments, the coupling may comprise a wired or wireless connection. In some embodiments, a shopping cart system may comprise a system connector configured to couple to a cart connector of a central computer system, a POS terminal, a cart return area, and/or an exit of the store. In some embodiments, a shopping cart connector and the system connector may comprise physical couplers configured to make contact with each other. For example, when a shopping cart is pushed through a POS, an electrical contact of the shopping cart may come in contact with another electrical contact at the POS. In some embodiments, the connectors may comprise wireless data connections such as one or more of a Wi-Fi transceiver, a Bluetooth transceiver, a near field communication (NFC) transceiver, a radio frequency transceiver, etc. In some embodiments, the wireless coupling may occur when the shopping cart passes through or near areas of the store with a wireless transceiver. In some embodiments, the shopping cart and the central system may be coupled via one or more of the shopping cart connector 265 and the system connector 213 described with reference to FIG. 2 or similar devices.

In step 502, the system receives energy information from a shopping cart system. In some embodiments, the energy information may comprise the charge level of a power storage device on the shopping cart system. In some embodiments, the system may be configured to measure the power storage devices' state of charge through the connectors. In some embodiments, the system may be configured retrieve energy information from a memory storage device on the shopping cart system via the connectors. In some embodiments, the shopping cart may be configured to aggregate the energy information over time as the shopping cart travels and store the energy information in the memory storage device. In some embodiments, the energy information may comprise a history of energy generated by the power generator. For example, the shopping cart system may comprise a voltmeter for measuring the output of the power generator over time. In some embodiments, the voltmeter may further measure the energy consumed by the power assist motors of the shopping cart system over time. In some embodiments, the energy information may comprise a history of a stored energy level of the power storage device. For example, the shopping cart system may comprise a state of charge sensor that is configured to measure the charge level of the power storage device periodically.

In step 503, the system estimates a distance traveled by the shopping cart system based on the energy information. In some embodiments, the distance traveled may be determine based on the power storage device's state of charge when the shopping cart arrives at a POS terminal. In some embodiments, the distance traveled may be determined based the amount of power added to the power storage device since the shopping cart left the shopping cart retrieval area and/or last visited a POS terminal. In some embodiments, the estimation may be based on the amount of charge at the end of the shopping trip only if the shopping cart does not have power assist capabilities and/or if the power assist function is turned off during the shopping trip. Generally, a greater amount of charged added to the power storage device correspond to a greater distance traveled by the customer for that shopping trip. For example, in some cases, 20 watt-hours of added charge may correspond to approximately 500 feet of distance traveled, etc.

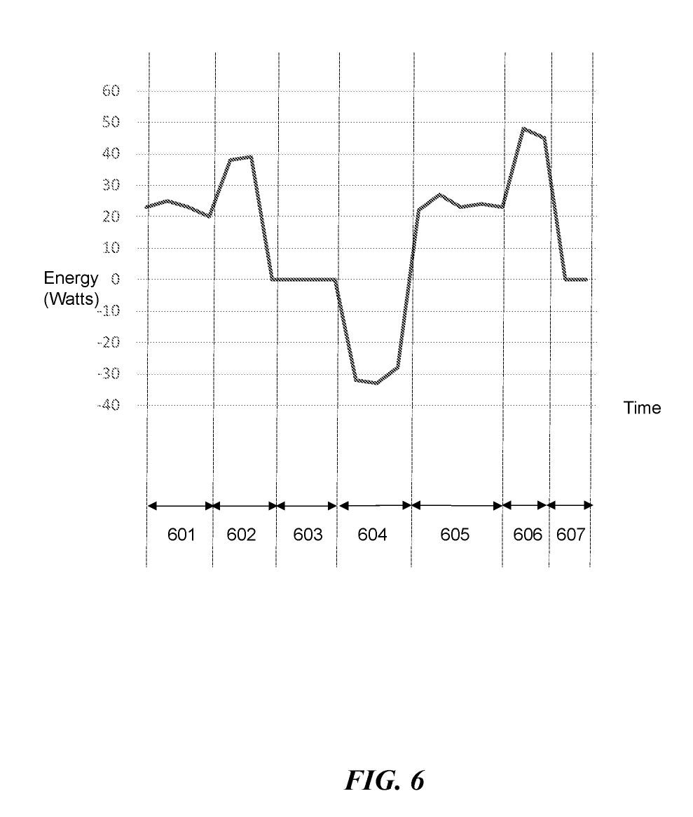

In some embodiments, the distance traveled by the shopping cart may be estimated based on energy information aggregated over time as the shopping cart travels. In some embodiments, the distance traveled may be determined based on how much energy is added and/or removed from the power storage device over time during the shopping trip. In some embodiments, the system may determine whether the shopping cart is traveling with power assist, traveling without power assist, braking, or stopped at different time periods of the shopping trip based on the energy information. In some embodiments, the system may determine whether the shopping cart is traveling with or without power system, stopped, or braking based on the amount of energy used and/or generated in a given time period. In some embodiments, the distance traveled may be estimated based the amount of time the shopping cart is traveling without power assist, traveling with power assist, and braking. In some embodiments, the distance traveled may further be estimated based on the amount of energy generated and/or used when is traveling without power assist, traveling with power assist, braking, and/or stopped. For example, the system may estimate the shopping cart's traveling speed based on the amount of energy generated by the generators device on the shopping cart as the shopping cart is traveling. The speed information may then be combined with travel duration information to determine travel distances associated with each time period. An example of an aggregated energy information of a shopping cart is provided in FIG. 6.

In step 504, the system detects for shopping cart stop events based on the energy information. In some embodiments, stop events may comprise regenerative braking events. For example, a stop event may be detected based on detecting a sudden increase of power generated by the generator corresponding to regenerative braking. In some embodiments, stop events may comprise periods of no energy usage or generation.

In step 505, the system estimates a weight of items in the shopping cart based on the amount of energy associated with each of the one or more shopping cart stop events. In some embodiments, a heavier cart may correspond to a greater amount of energy being generated via regenerative braking. In some embodiments, the system may further be configured to detected item added events and item removed events based on changes in the weight of items in the shopping cart between stop events. For example, if the system detects an increase in the energy associated with braking a shopping cart, the system may assume that one or more items have been added to the shopping cart during or since the last time the shopping cart made a stop.

In some embodiments, the system may further correlate the energy information with customer purchases associated with the shopping cart system. In some embodiments, the system may associate a purchase with a shopping cart that is at the POS terminal when the purchase is made. In some embodiments, the system may identify the location of each item purchased by the customer and combine the locations of the items and the distances traveled to estimate a route of the customer. In some embodiments, the system may compare the locations of the items with the timing of the stop events detected in the energy information to estimate the in-store route of the customer. In some embodiments, the energy information may further be used to determine dwell times at one or more locations in the store. For example, if the shopping cart charged for 20 seconds after leaving the cart retrieval area and the cart generated no charge for 10 seconds after, the system may assume that the customer dwelled at a location approximately 70 feet from the cart retrieval area for 10 seconds. The system may then determine whether any of the items purchased by the customer is displayed approximately 70 feet away from the cart retrieve area to identify the product and/or display area associated with the stop event and dwell time. In some embodiments, the system may determine whether any item is selected from the first stop based on comparing the amount of power assist needed and/or the amount of power associated regenerative braking subsequent to the stop. For example, if power assist is not triggered when the cart is initially picked up by the customer but is triggered after the first stop on the sales floor, the system may assume one or more item have been added to the cart at the stop. With the recorded energy information, the system may be configured to determine when and where customers traveled, stopped, added items to the shopping cart, and/or remove items from the shopping cart.

In some embodiments, steps 501-505 may be performed each time a shopping cart is used by a customer. In some embodiments, when a shopping cart is returned to a cart return or retrieval area, the energy information may be reset for the next customer. For example, the base charge level of the energy storage device may be reset in the system such that when the shopping cart is returned, the system may determine the change in energy storage. Steps 501-505 may be repeated when the next customer subsequently brings the shopping cart to one or more of a POS system, a cart return area, and/or an exit of the store. In some embodiments, the system may aggregate the total distance traveled by a shopping cart over a plurality of customer shopping trips to determine whether to schedule maintenance tasks for the shopping cart. In some embodiments, multiple instances of steps 501-505 may occur simultaneously at a central computer system for a plurality of shopping cart systems. In some embodiments, the system may further aggregate travel distances and stop event information for a plurality of shopping cart over time to determine store-wide trends. For example, if a change in store configuration leads to an increase of average distance traveled by shopping carts, the store may reconsider the change in store configuration.

FIG. 6 comprises an illustration of a record of energy information. In FIG. 6, the energy added to or removed from a power storage device of a shopping cart system is shown. In some embodiments, the energy shown in FIG. 6, may comprise energy added and removed from the power storage 230 and/or passes through the switch 235 as described with reference to FIG. 2 or similar components. In phase 601, the shopping cart is traveling without power assist and generates about 20 watts of energy with a generator coupled to the wheels. During phase 601, the system may be detecting a forward pressure on the pressure sensors on the handle of the shopping cart that is below a threshold that would trigger the power assist function of the shopping cart. In phase 602, regenerative braking is triggered and generates approximately 40 watts of energy. In some embodiments, regenerative braking may be trigger by the customer pulling back on the handle and/or letting go of the handle of the shopping cart. The regenerative braking is applied to bring the shopping cart to a stop. In phase 603, the shopping cart is in a stopped state where no energy is generated or expended. In phase 604, the power assist function is triggered and energy is supplied to the motors of the shopping cart. In some embodiments, power assist may be triggered if a forward pressure on the pressure sensors on the handle of the shopping cart exceeds a threshold. In phase 605, power assist is turned off as the shopping cart continues to travel forwards. In some embodiments, power assist may be turned off when the forward pressure on the handle of the shopping cart falls back below the trigger threshold. In some embodiments, the power assist may be configured to taper off by gradually decreasing the amount torque generated by the motors. In some embodiments, the customer may continue to push the shopping cart in phase 605. In phase 606, regenerative braking is again applied to generate 50 watts of energy. In some embodiments, the system may be configured to compare the energy generated during phases 602 and 606 to determine whether weight has been added to the shopping cart. In this case, the system may determine that items were added during one or of phases 603-605 because more energy is generated by the regenerative braking in phase 606 as compared to phase 602. In some embodiments, the system may further consider the speed of the shopping cart when regenerative braking is triggered to determine whether weight has been added to the shopping cart. In some embodiments, the speed of travel may be estimated by the amount of energy generated when the shopping cart is traveling forward without power assist, such as in phases 601 and 605. In some embodiments, the system may similarly compare the amount of energy used to provide power assist to move the cart from a stopped state to determine whether weight has been added to the shopping cart. Generally, heavier the cart, more energy is required to provide power assist to overcome the inertia.

In some embodiments, the system may use a record of energy information such as shown in FIG. 6 to determine how many times a customer stopped during a shopping trip. In some embodiments, the dwell time at each stop may be determined based on the duration of stop phases such as phases 603 and 607. In some embodiments, the system may further estimate the distance of the shopping trip based on the durations and energy associated time periods in which the shopping cart is moving such as phases 601-602 and 604-606. In some embodiments, the system may determine the customer's speed of travel based on the amount of energy generated in traveling phases that do not engage power assist or braking such as phase 601 and 605. In some embodiments, the energy used and/or generated by power assist and regenerated braking may be used to detect for weight changes of the content of the shopping cart.

The energy levels and durations in FIG. 6 are provided for illustration only and may not be to scale or corresponds to actual data. The durations and magnitudes of each phase may be longer or shorter based on how customers interact with shopping carts. The amount of energy charged or used in each phase may further vary depend on a variety of mechanical, electrical, human, and environmental factors.

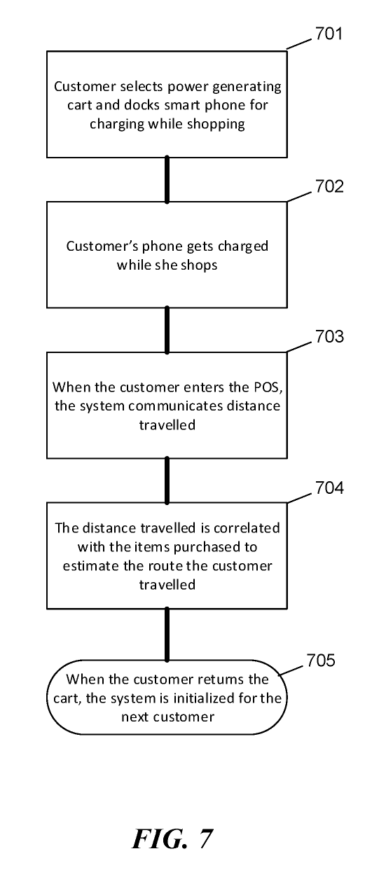

Referring now to FIG. 7, a method for tracking shopping cart activity is shown. In some embodiments, the steps of FIG. 7 may be performed by a control circuit of a shopping cart system, a central computer system, and/or a POS system. In some embodiments, the steps of FIG. 7 may be performed by the central computer system 260 and/or the shopping cart system 200 described with reference to FIG. 2 or similar devices.

In step 701, the customer selects a power generating shopping cart and docks a smartphone to the shopping cart for charging while shopping. In step 702, the customer's phone is charged while she shops. In step 703, when the customer enters a POS, the system communicates the distance traveled by the customer to the POS. In some embodiments, the distance traveled may be determined based on the amount of charge generated by the shopping cart during the trip and/or energy information record over time. In some embodiments, the customer smartphone may be coupled to the shopping cart's charging system to record energy information and transmit the recorded information to the POS. In step 704, the distance traveled determine in step 703 is correlated with the items purchased by the customer to estimate the route that customer traveled. In some embodiments, the system may identify the locations of the items purchased by the customer based on a store layout and determine a route matching that travel distance that would cover all item locations on the sale floor to be the customer's shopping route. In step 705, when the customer returns the cart, the shopping cart's charge and/or travel record are initialized for the next customer.

In some embodiments, a system comprises a power assisted shopping cart for customers who lack the ability to push a laden shopping cart in the store. The shopping cart system may feature driving controls on the handles. In some embodiments, a force exerted evenly on the left and right sides of the handle may cause the cart to move straight. In some embodiments, a force on the right side may cause the cart to move to the left. In some embodiments, pulling back on the cart while the cart is moving may provide a braking action. In some embodiments, once the cart is stopped, pulling back on the handle may cause the cart to reverse slowly. In some embodiments, the shopping cart may further comprise a dead-man feature that causes the cart to stop if no pressure is detected. In some embodiments, the motor in the shopping cart may provide power assist to overcome the initial inertia and, once moving, only provide assist to maintain movement. For example, during forward travel, the power assist function may turn on and off based on whether the pressure on the handle exceeds a threshold. When the power assist is not engaged, the forward motion of the shopping cart may be used to charge the power storage device of the power assist. In some embodiments, the shopping cart system comprises a powered cart that reverses a power generator to function as a motor to assist elderly customers to push carts.

In some embodiments, the systems described herein comprises a shopping cart that includes a generator driven by one or more wheels of the cart. In some embodiments, the system may estimate the distance traveled by the customer based on the power generated by the cart. In some embodiments, the system may use the determined travel distance to plan for cart maintenance and/or infer the path of the customer based on the distance traveled and products purchased by the customer.

In one embodiment, a system for providing shopping cart power assist comprises a pressure sensor device on a handle portion of a shopping cart, a power generator configured to generate power with a rotation of a wheel system of the shopping cart, a power storage device configured to be charged by the power generator, a motor configured to drive the wheel system of the shopping cart with power from the power storage device, and a control circuit coupled to the pressure sensor device and the motor, the control circuit being configured to: detect for pressure on the handle portion of the shopping cart based on the pressure sensor device, in an event that a forward pressure on the handle portion is below a threshold, cause the power generator to charge the power storage device, and in an event that the forward pressure on the handle portion exceeds the threshold, cause the motor to drive the wheel system to generate forward propulsion for the shopping cart.

In one embodiment, a method for providing shopping cart power assist comprises detecting for pressure on with a pressure sensor device on a handle portion of a shopping cart, in an event that a forward pressure on the handle portion is below a threshold, causing, with a control circuit, a power generator configured to generate power with a rotation of a wheel system of the shopping cart to charge a power storage device, and in an event that the forward pressure on the handle portion exceeds the threshold, causing, with the control circuit, a motor to drive the wheel system to generate forward propulsion for the shopping cart with power from the power storage device.

In one embodiment, a shopping cart apparatus comprises a container portion configured to hold a plurality of items, a handle portion comprising a pressure sensor device, a power storage device, a wheel system coupled to a power generator configured to generate power with a rotation of the wheel system and a motor configured to drive the wheel system, and a frame portion coupled to the container portion, the handle portion, the power storage device, and the wheel system, wherein when a forward pressure detected by the pressure sensor device is below a threshold, the power generator charges the power storage device, and wherein when the forward pressure detected by the pressure sensor device exceeds the threshold, the motor drives the wheel system to generate forward propulsion.

In one embodiment, a system for tracking shopping cart activity comprises a shopping cart system comprises a power generator configured to generate power with a rotation of a wheel system of the shopping cart, a power storage device configured to be charged by the power generator, and a system connector configured to couple with a computer system to provide energy information associated with the charging of the power storage, the computer system comprising: a shopping cart connector configured to couple with the system connector to receive the energy information from the shopping cart system, and a control circuit configured to estimate a distance traveled by the shopping cart system based on the energy information.

In one embodiment, a method for tracking shopping cart activity comprises coupling a system connector of a shopping cart system with a shopping cart connector of a computer system, receiving, at a control circuit and via a shopping cart connector, energy information from the shopping cart system comprising: a power generator configured to generate power with a rotation of a wheel system of a shopping cart, and a power storage device configured to be charged by the power generator, and estimating, with the control circuit, a distance traveled by the shopping cart system based on the energy information.

In one embodiment, a shopping cart apparatus comprises a power generator configured to generate power with a rotation of a wheel system of a shopping cart, a power storage device configured to be charged by the power generator, a memory storage device, a control circuit configured to determine an amount of energy generated by the power generator and store the amount of energy generated by the power generator in the memory storage device over time to create a record of energy information for the shopping cart, and a system connector configured provide the record of energy information to a computer system.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for providing shopping cart power assist comprising:
a pressure sensor device on a handle portion of a shopping cart;
a power generator configured to generate power with a rotation of a wheel system of the shopping cart;
a power storage device configured to be charged by the power generator;
a motor configured to drive the wheel system of the shopping cart with power from the power storage device; and
a control circuit coupled to the pressure sensor device and the motor, the control circuit being configured to:
detect for pressure on the handle portion of the shopping cart based on the pressure sensor device;
in an event that a forward pressure on the handle portion is below a threshold, cause the power generator to charge the power storage device; and
in an event that the forward pressure on the handle portion exceeds the threshold, cause the motor to drive the wheel system to generate forward propulsion for the shopping cart.

2. The system of claim 1, wherein:
the pressure sensor device comprises a right pressure sensor and a left pressure sensor spaced apart from each other on the handle portion of the shopping cart.

3. The system of claim 2, wherein:
the wheel system comprises a powered right wheel and a powered left wheel; and
the control circuit is configured to drive the powered right wheel based on a first pressure detected at the right pressure sensor and drive the powered left wheel based on a second pressure detected at the left pressure sensor.

4. The system of claim 1, wherein: in an event that a backward pressure or no pressure is detected at the pressure sensor device, the control circuit is configured to bring the shopping cart to a stop.

5. The system of claim 4, wherein the control circuit is further configured to cause the power generator to charge the power storage device while bringing the shopping cart to a stop.

6. The system of claim 4, wherein the control circuit is further configured to record an amount of energy associated with bringing the shopping cart a stop.

7. The system of claim 1, wherein, in an event that the forward pressure on the handle portion falls below the threshold while the motor is driving the wheel system, the control circuit is configured to turn off the motor and charge the power storage device with the power generator coupled to the wheel system.

8. The system of claim 1, wherein the power storage device comprises one or more of a battery and a capacitor.

9. The system of claim 1, wherein the power generator and the motor comprise a combined motor and generator device.

10. The system of claim 1, wherein the wheel system of the shopping cart comprises one or more powered and unpowered wheels.

11. A method for providing shopping cart power assist comprising:
detecting for pressure on with a pressure sensor device on a handle portion of a shopping cart;
in an event that a forward pressure on the handle portion is below a threshold, causing, with a control circuit, a power generator configured to generate power with a rotation of a wheel system of the shopping cart to charge a power storage device; and
in an event that the forward pressure on the handle portion exceeds the threshold, causing, with the control circuit, a motor to drive the wheel system to generate forward propulsion for the shopping cart with power from the power storage device.

12. The method of claim 11, wherein:
the pressure sensor device comprises a right pressure sensor and a left pressure sensor spaced apart from each other on the handle portion of the shopping cart.

13. The method of claim 12, wherein:
the wheel system comprises a powered right wheel and a powered left wheel; and
causing the motor to drive the wheel system comprises driving the powered right wheel based on a first pressure detected at the right pressure sensor and driving the powered left wheel based on a second pressure detected at the left pressure sensor.

14. The method of claim 11, further comprising:
in an event that a backward pressure or no pressure is detected at the pressure sensor device, bringing the shopping cart to a stop.

15. The method of claim 14, further comprising:
causing the power generator to charge the power storage device while bringing the shopping cart to a stop.

16. The method of claim 14, further comprising:
recording an amount of energy associated with bringing the shopping cart a stop.

17. The method of claim 11, further comprising:
in an event that the forward pressure on the handle portion falls below the threshold while the motor is driving the wheel system, turning off the motor and charging the power storage device with the power generator coupled to the wheel system.

18. The method of claim 11, wherein the power storage device comprises one or more of a battery and a capacitor.

19. The method of claim 11, wherein the power generator and the motor comprise a combined motor and generator device.

20. A shopping cart apparatus comprising:
a container portion configured to hold a plurality of items;
a handle portion comprising a pressure sensor device;
a power storage device;
a wheel system coupled to a power generator configured to generate power with a rotation of the wheel system and a motor configured to drive the wheel system; and
a frame portion coupled to the container portion, the handle portion, the power storage device, and the wheel system;
wherein when a forward pressure detected by the pressure sensor device is below a threshold, the power generator charges the power storage device; and
wherein when the forward pressure detected by the pressure sensor device exceeds the threshold, the motor drives the wheel system to generate forward propulsion.
